(19) United States
(12) Patent Application Publication
(10) Pub. No.: US 2015/0336645 A1
(43) Pub. Date: Nov. 26, 2015

(54) AUTONOMOUS UNDERWATER VEHICLE MARINE SEISMIC SURVEYS

(71) Applicant: CGG SERVICES SA, Massy (FR)

(72) Inventors: Thierry Brizard, Massy (FR); Jonathan Grimsdale, Massy (FR); Alice Herve, Massy (FR); Ivan Torres Tamanaja, Massy (FR)

(73) Assignee: CGG Services SA, Massy (FR)

(21) Appl. No.: 14/648,493

(22) PCT Filed: Dec. 19, 2013
(86) PCT No.: PCT/EP2013/077507

§ 371 Date: May 29, 2015

(30) Foreign Application Priority Data
Dec. 20, 2012 (FR) 1262463

(51) Int. Cl. B63G 8/00; G01V 1/38

(52) U.S. Cl. CPC B63G 8/001; G01V 1/3852; G01V 1/3808; B63G 2008/004

(57) ABSTRACT

An autonomous underwater vehicle (AUV) for recording seismic signals during a marine seismic survey. The AUV (200) includes a body (204) having a flush shape; a buoyancy system (202) located inside the body and configured to control a buoyancy of the AUV while traveling underwater; a processor (108) connected to the buoyancy system and configured to select one of plural phases for the buoyancy system at different times of the seismic survey, wherein the plural phases include a neutral buoyancy, a positive buoyancy and a negative buoyancy; and a seismic sensor (110) for recording seismic signals.

### BACKGROUND

1. Technical Field

Embodiments of the subject matter disclosed herein generally relate to methods and systems and, more particularly, to mechanisms and techniques for performing a marine seismic survey using autonomous underwater vehicles (AUVs) that carry appropriate seismic sensors and has a multi-phase buoyancy system.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Reflection seismology is a method of geophysical exploration to determine the properties of earth's subsurface, which are especially helpful in determining the above noted reservoirs. Marine reflection seismology is based on using a controlled source of energy that sends the energy into the earth. By measuring the time it takes for the reflections and/or refractions to come back to plural receivers, it is possible to evaluate the depth of features causing such reflections. These features may be associated with subterranean hydrocarbon deposits.

A traditional system for generating the seismic waves and recording their reflections off the geological structures present in the subsurface is illustrated in FIG. 1. A vessel 10 tows an array of seismic receivers 11 provided on streamers 12. The streamers may be disposed horizontally, i.e., lying at a constant depth relative to a surface 14 of the ocean. The streamers may be disposed to have other than horizontal spatial arrangements. The vessel 10 also tows a seismic source array 16 that is configured to generate a seismic wave 18. The seismic wave 18 propagates downwards toward the seafloor 20 and penetrates the seafloor until eventually a reflecting structure 22 (reflector) reflects the seismic wave. The reflected seismic wave 24 propagates upwardly until it is detected by the receiver(s) 11 on the streamer(s) 12. Based on the data collected by the receiver(s) 11, an image of the subsurface is generated.

However, this traditional configuration is expensive as the cost of the streamers is high. New technologies deploy plural seismic sensors on the bottom of the ocean (ocean bottom stations) to improve the coupling. Even so, positioning the seismic sensors remains a challenge.

Other technologies use permanent receivers set on the sea bottom, as disclosed in U.S. Pat. No. 6,932,185, the entire content of which is incorporated herein by reference. In this case, the seismic sensors 60 are attached, as shown in FIG. 2 (which corresponds to FIG. 4 of the patent), to a heavy pedestal 62. A station 64 that includes the sensors 60 is launched from a vessel and arrives, due to its gravity, to a desired position. The station 64 remains on the bottom of the ocean permanently. Data recorded by sensors 60 are transferred through a cable 66 to a mobile station 68. When necessary, the mobile station 68 may be brought to the surface to retrieve the data.

Although this method provides a better coupling between the ocean bottom and the sensors, the method is still expensive and not flexible as the sensors and corresponding pedestals are left on the sea floor. Further, positioning the sensors is not straightforward.

An improvement to this method is described, for example, in European Patent No. EP 1 217 390, the entire content of which is incorporated herein by reference. In this document, a sensor 70 (see FIG. 3) is removably attached to a pedestal 72 together with a memory device 74. After recording the seismic waves, the sensor 70 together with the memory device 74 are instructed by a vessel 76 to detach from the pedestal 72 and to surface at the ocean surface 78 to be picked up by the vessel 76.

However, this configuration is not very reliable as the mechanism maintaining the sensor 70 connected to the pedestal 72 may fail to release the sensor 70. Also, the sensor 70 and pedestal 72 may not achieve their intended positions on the seabed. Further, the fact that the pedestals 72 are left behind increase ocean pollution and the survey price, which is undesirable.

Accordingly, it would be desirable to provide systems and methods that provide an inexpensive and non-polluting device for reaching the sea floor, recording seismic waves and resurfacing for data transfer.

### SUMMARY

According to one exemplary embodiment, there is an autonomous underwater vehicle (AUV) for recording seismic signals during a marine seismic survey. The AUV includes a body having a flush shape; a buoyancy system located inside the body and configured to control a buoyancy of the AUV while traveling underwater; a processor connected to the buoyancy system and configured to select one of plural phases for the buoyancy system at different times of the seismic survey, wherein the plural phases include a neutral buoyancy phase, a positive buoyancy phase and a negative buoyancy phase; and a seismic sensor for recording seismic signals.

According to another exemplary embodiment, there is an autonomous underwater vehicle (AUV) for recording seismic signals during a marine seismic survey. The AUV includes a body having a flush shape; a buoyancy system located inside the body and configured to control a buoyancy of the AUV while underwater; a processor connected to the buoyancy system and configured to select one of plural phases for the buoyancy system at different times of the seismic survey, wherein the plural phases include a neutral buoyancy, a positive buoyancy and a negative buoyancy; a propulsion system configured to guide the AUV to a target position on the sea bottom; and a seismic sensor for recording seismic signals.

According to still another exemplary embodiment, there is a method for driving an autonomous underwater vehicle (AUV) for recording seismic signals during a marine seismic survey. The method includes releasing the AUV in the water, the AUV having a flush shape body and a positive buoyancy; controlling a buoyancy system located inside the body while the AUV is traveling underwater; selecting with a processor one of plural phases for the buoyancy system at different times of the seismic survey, wherein the plural phases include a neutral buoyancy, a positive buoyancy and a negative buoyancy; and recording with a seismic sensor seismic signals when the buoyancy system has a negative buoyancy.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic survey system;

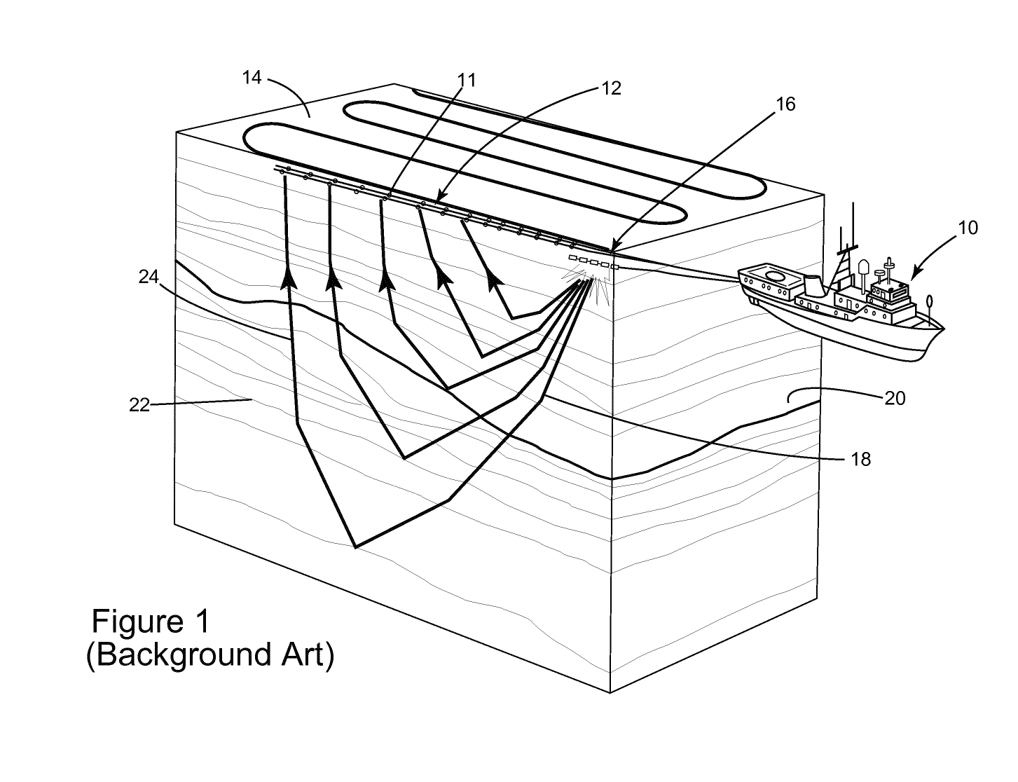

FIG. 2 is a schematic diagram of a station that may be positioned on the bottom of the ocean for seismic data recording;

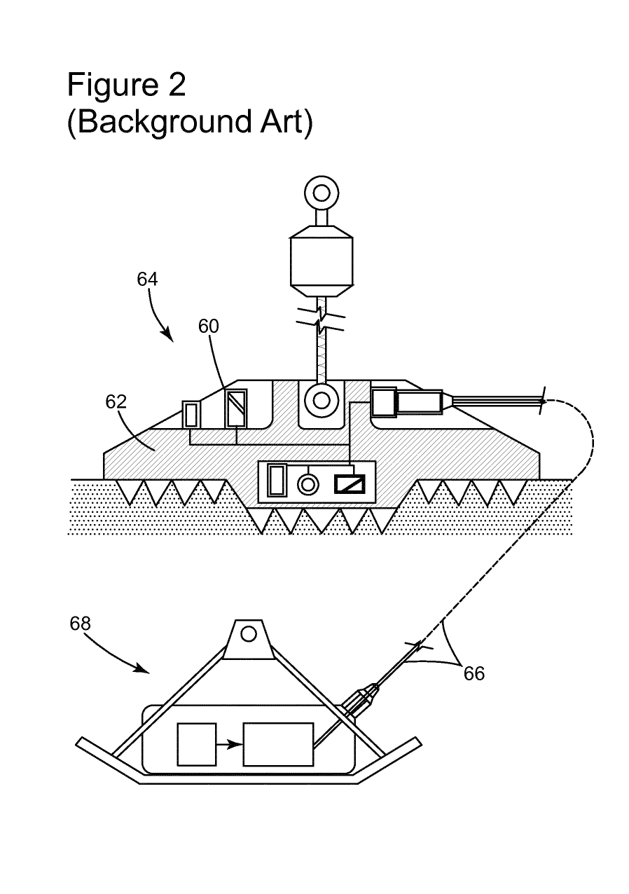

FIG. 3 is a schematic diagram of another station that may be positioned on the bottom of the ocean for seismic data recording;

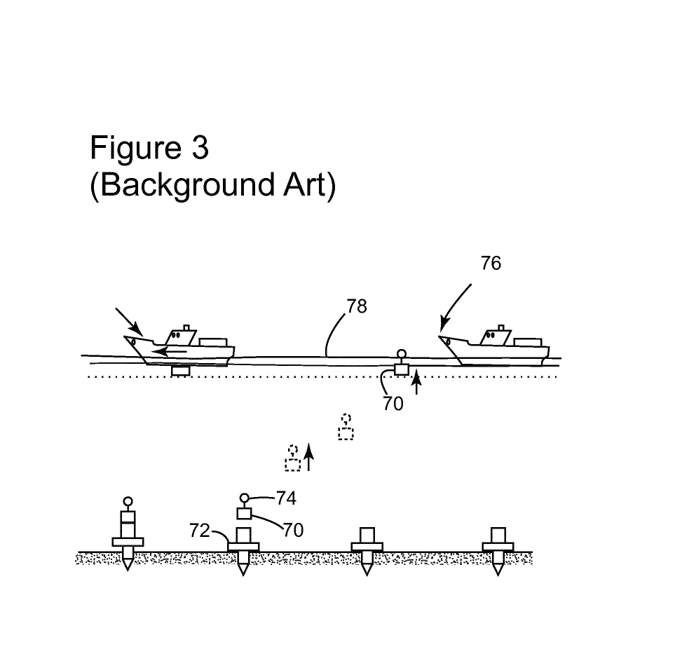

FIG. 4 is a schematic diagram of an AUV according to an exemplary embodiment;

FIG. 5 is a schematic diagram of a buoyancy system of an AUV according to an exemplary embodiment;

FIG. 6 is a schematic diagram of another AUV according to an exemplary embodiment;

FIG. 7 is a schematic diagram of still another AUV according to an exemplary embodiment;

FIG. 8 is a schematic diagram of a process for deploying and recovering AUVs according to an exemplary embodiment;

FIG. 9 is a flowchart of a method for recycling AUVs during a seismic survey according to an exemplary embodiment;

FIG. 10 is a schematic diagram of an AUV according to another exemplary embodiment;

FIG. 11 is a schematic diagram of an AUV according to still another exemplary embodiment; and

FIG. 12 is a flowchart of a method for deploying and recovering an AUV during a seismic survey.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an AUV having seismic sensors and a multi-phase buoyancy system. However, the embodiments to be discussed next are not limited to AUVs deployed from a vessel, but may be applied to other platforms (e.g., glider, buoy, etc.) that may include seismic sensors.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys need an inexpensive system for deploying and recovering seismic receivers at the bottom of the ocean. According to an exemplary embodiment, such a seismic system includes plural AUVs each having one or more seismic sensors. The seismic sensors may be one of a hydrophone, geophone, accelerometers, electromagnetic sensors, etc. If an electromagnetic sensor is used, then a source that emits electromagnetic waves may be used instead or in addition to an acoustic source.

The AUV may be a specially designed device or an off-the-shelf device so that it is inexpensive. The off-the-shelf device may be quickly retrofitted or modified to include the seismic sensors and necessary communication means to be discussed later. The AUV may include, besides or in addition to a propulsion system, a buoyancy system. The buoyancy system may be a multi-phase system as discussed later. A deployment vessel may store the AUVs and may launch them as necessary for the seismic survey. The AUVs find their target positions using, for example, an inertial navigation system, or another means. Thus, the AUVs may be preprogrammed or partially programmed to find their target positions. If the AUV are partially programmed, the final details for finding the target position may be received, e.g., acoustically, from the vessel when the AUV is launched from the vessel and/or while the AUV is navigating underwater. In the following, reference is made to a deployment vessel and/or a recovery vessel. It is noted that these vessels may be identical from an equipment point of view. However, the vessels may be operated as a recovery vessel or as a deployment vessel. In other words, a recovery vessel may be instructed, after having enough AUVs on board, to become a deployment vessel, and the other way around. When the document refers to a vessel, it might be the recovery vessel, the launching vessel or both of them.

As the deployment vessel is launching the AUVs, a shooting vessel may follow the deployment vessel for generating seismic waves. The shooting vessel may tow one or more seismic source arrays. The seismic source array may include plural individual seismic sources that may be arranged on horizontal line, slanted line or curved line under water. The individual seismic source may be an airgun or a vibrational source or other known seismic sources. The shooting vessel or another vessel, e.g., the recovering vessel, may then instruct selected AUVs to resurface so that they can be collected. In one embodiment, the deployment vessel also tows source arrays and shoots them as it deploys the AUVs. In still another exemplary embodiment, only the deployment vessel is configured to retrieve the AUVs. However, it is possible that only the shooting vessel is configured to retrieve the AUVs. Alternatively, a dedicated recovery vessel may wake-up the AUVs and instruct them to return to the surface for recovery.

In one exemplary embodiment, the number of AUVs is in the thousands. Thus, the deployment vessel is configured to hold all of them at the beginning of the survey and then to launch them as the seismic survey is advancing.

If the shooting vessel is configured to retrieve the AUVs, when the number of available AUVs at the deployment vessel is below a predetermined threshold, the shooting vessel and the deployment vessel are instructed to switch positions in the middle of the seismic survey. If a dedicated recovery vessel is used to recover the AUVs, then the deployment vessel is configured to switch positions with the recovery vessel when the deployment vessel becomes empty. In another exemplary embodiment, both vessels are full with AUVs. The first one starts deploying the AUVs and the second one just follow the first one. Once the first one has deployed most or all the AUVs, this vessel becomes the recovery vessel and the second one starts deploying AUVs, thus becoming the deployment vessel. Later, the two vessel may switch functions as necessary.

In an exemplary embodiment, the seismic survey is performed as a combination of seismic sensors of the AUVs and seismic sensors of streamers towed by the deployment vessel, or the shooting vessel or by both of them.

In still another exemplary embodiment, when selected AUVs are instructed to surface, they may be programmed to go to a desired rendezvous point where they will be collected by the shooting vessel or by the deployment vessel or by the recovery vessel. The selected AUVs may be chosen to belong to a given row or column if a row and column arrangement is used. The shooting or/and deployment or recovery vessel may be configured to send acoustic signals to the returning AUVs for guiding them to the desired position. The AUVs may be configured to rise to a given altitude, execute the return back path at that altitude and then surface for being recovered. In one exemplary embodiment, the AUVs are configured to communicate among them so that they follow each other in their path back to the recovery vessel or they communicate among them to establish a queuing line for being retrieved by the shooting or recovery or deployment vessel.

Once on the vessel, the AUVs are checked for problems, their batteries may be recharged or replaced and the stored seismic data may be transferred to the vessel for processing. Alternatively or in addition, a compressed gas tank may be replaced or recharged for powering the buoyancy system of the AUV. The recovery vessel may store the AUVs on deck during the maintenance phase or somewhere inside the vessel, e.g., inside of a module, closed or open, that is fixed on the vessel or the vessel's deck. A conveyor-type mechanism may be designed to recover the AUVs on one side of the vessel, when the vessel is used as a recovery vessel, and to launch the AUVs on another side of the vessel when the vessel is used as a deployment vessel. After this maintenance phase, the AUVs are again deployed as the seismic survey continues. Thus, in one exemplary embodiment the AUVs are continuously deployed and retrieved. In still another exemplary embodiment, the AUVs are configured to not transmit the seismic data to the deployment or recovery or shooting vessel while performing the seismic survey. This may be advantageous as the electric power available on the AUV may be limited. In another exemplary embodiment, each AUV has enough electric power (stored in the battery) to only be once deployed, record seismic data and resurface to be retrieved. Thus, reducing the data transmission amount between the AUV and the vessel while the AUV is underwater conserves the power and allows the AUV to be retrieved on the vessel before running out of power.

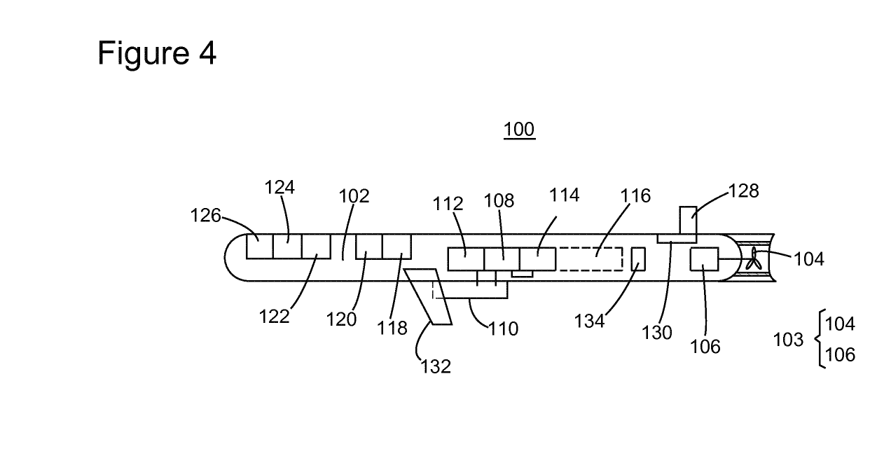

The above-noted embodiments are now discussed in more detail with regard to the figures. FIG. 4 illustrates an AUV 100 having a body 102 in which a propulsion system 103 may be located. It is noted that in one embodiment, there is no propulsion system. If the propulsion system 103 is available, it may include one or more propellers 104 and a motor 106 for activating the propeller 104. Alternatively, the propulsion system may include adjustable wings for controlling a trajectory of the AUV. The motor 106 may be controlled by a processor 108. The processor 108 may also be connected to a seismic sensor 110. The seismic sensor 110 may have such a shape that when the AUV lands on the seabed, the seismic sensor achieves a good coupling with the sediments on the seabed. The seismic sensor may include one or more of a hydrophone, geophone, accelerometer, etc. For example, if a 4C (four component) survey is desired, the seismic sensor 110 includes three accelerometers and a hydrophone, i.e., a total of four sensors. Alternatively, the seismic sensor may include three geophones and a hydrophone. Of course other combinations of sensors are possible.

A memory unit 112 may be connected to the processor 108 and/or the seismic sensor 110 for storing seismic data recorded by the seismic sensor 110. A battery 114 may be used to power up all these components. The battery 114 may be allowed to change its position along a track 116 to change a center of gravity of the AUV.

The AUV may also include an inertial navigation system (INS) 118 configured to guide the AUV to a desired location. An inertial navigation system includes at least a module containing accelerometers, gyroscopes, or other motion-sensing devices. The INS is initially provided with the current position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation, or velocity once it has been initialized. Further, the usage of the INS is inexpensive.

Besides or instead the INS 118, the AUV may include a compass 120 and other sensors 122, as for example, an altimeter for measuring its altitude, a pressure gauge, an interrogator module, etc. The AUV 100 may optionally include an obstacle avoidance system 124 and a communication device 126 (e.g., wi-fi device) or other data transfer device that is capable to wirelessly transfer seismic data. In one embodiment, the transfer of seismic data takes place while the AUV is on the vessel. Also, it is possible that the communication device 126 is a port that is wired connected to the vessel to transfer the seismic data. One or more of these elements may be linked to the processor 108. The AUV further includes an antenna 128 (which may be flush with the body of the AUV) and a corresponding acoustic system 130 for communicating with the deploying, recovery or shooting vessel. Stabilizing fins and/or wings 132 for guiding the AUV to the desired position may be used together with the propulsion system 103 for steering the AUV. However, in one embodiment, the AUV has no fins or wings. The AUV may include a buoyancy system 134 for controlling a depth of the AUV as will be discussed later.

The acoustic system 130 may be an Ultra-short baseline (USBL) system, also sometimes known as Super Short Base Line (SSBL). This system uses a method of underwater acoustic positioning. A complete USBL system includes a transceiver, which is mounted on a pole under a vessel, and a transponder/responder on the AUV. A processor is used to calculate a position from the ranges and bearings measured by the transceiver. For example, an acoustic pulse is transmitted by the transceiver and detected by the subsea transponder, which replies with its own acoustic pulse. This return pulse is detected by the transceiver on the vessel. The time from the transmission of the initial acoustic pulse until the reply is detected is measured by the USBL system and is converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less.

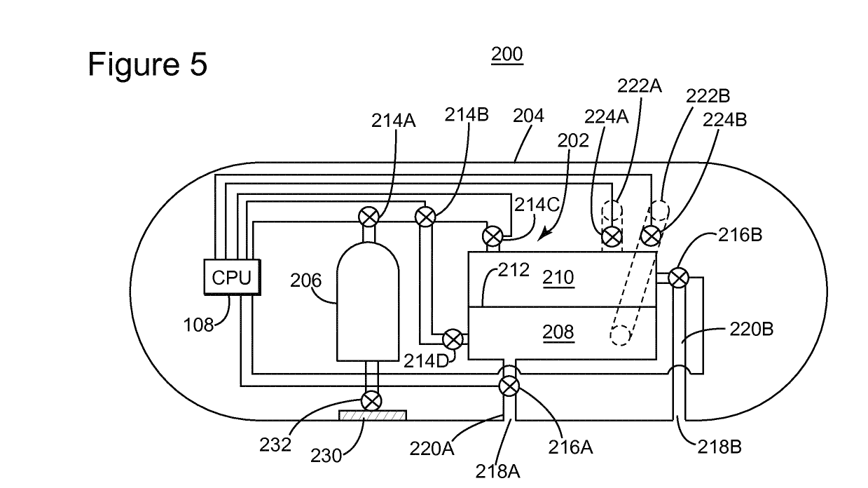

FIG. 5 shows an AUV 200 for which only the buoyancy system 202 is illustrated for simplicity. All or fewer of the components of the AUV 100 discussed above may be present in the AUV 200. The buoyancy system 202 may be located inside the body 204 of the AUV 200. The buoyancy system 202 may include a compressed gas tank 206 that is connected through plural pipes and valves to one or more chambers. FIG. 5 shows two chambers 208 and 210 separated by a common wall 212. However, in one embodiment the buoyancy system has only one chamber. In another embodiment, the buoyancy system has three or more chambers. In the following, a buoyancy system having two chambers is described for simplicity. However, the operation principles described below apply in a similar manner to one or more chambers.

The compressed gas tank 206 may be filled with any gas, for example, air, CO₂, etc. A gas valve 214A may be installed to control the compressed gas' flow from the gas tank 206 to one or both of the chambers 208 and 210. Additional gas valves 214B-D may be installed along the piping to control which of the chamber receives the compressed gas. The chambers are also configured to receive water for altering the overall buoyancy of the AUV. Thus, water valves 216A-B may be installed between each chamber and corresponding ports 218A-B. The ports 218A-B may be located on the outside of the body 204 of the AUV. Further, the chambers are provided with evacuation ports 222A and 222B located on the outside of the AUV. These ports communicate with the chambers so that the air inside the chambers is evacuated when the chambers are flooded with water through ports 218A and 218B. Corresponding air evacuation valves 224A and 224B control the air evacuation and these valves are connected to the processor 108. It is noted that FIG. 5 shows schematically (not at scale) the location of the valves, piping and ports, i.e., the valves and ports may be placed at other locations along the piping for achieving the same effect. The valves may be electromagnetic valves that are electrically controlled by the processor 108.

In operation, the buoyancy system 202 is configured to work as follows. Consider that the AUV 200 is just being released into the water and it may have positive buoyancy. For this situation, both chambers 208 and 210 are filed with air. All the valves of the system may be in the closed position. Thus, the AUV 200 floats at the water surface. Detecting that it is in water, the processor 108 instructs the valve 216A to switch to the open position, to allow water to enter inside the chamber 208 and at the same time, the processor 108 instructs the valve 224B to open to allow the air inside the chamber 208 to escape outside. The valves 216A and 224B may be closed as soon the chamber 208 is flooded. Alternatively, both valves remain open as the AUV travels to its final destination. At this time, the buoyancy of the AUV becomes neutral or slightly negative and the AUV starts its journey towards a target position at the sea bottom. This is phase one of the AUV. To achieve buoyancy that is neutral or slightly negative, the volume (size) of chamber 208 is calculated based on the overall weight of the AUV. The AUV may use its propulsion system or other systems to arrive at the target position, i.e., to adjust its position in a plane substantially parallel with the water surface while descending toward the target position.

When the AUV reaches the target position, for example, on the sea bottom, the AUV needs to make a good coupling with the bottom so that the seismic sensor(s) record a high quality seismic signal. To achieve this goal, and also to stabilize the AUV on the sea bottom, the valve 2168 is opened so that water enters inside the chamber 210 and valves 224A is also opened so that the inside air can escape. In this second phase, the buoyancy of the AUV is made negative, thus increasing the coupling with the sea bottom. Thus, in this phase, both chambers 208 and 210 are freely communicating with the water ambient of the AUV. All the gas valves 214A-D may be closed at this time.

The processor 108 may determine that the AUV has reached the target position by monitoring the depth sensor and determining that the depth of the AUV does not change. Alternatively, an accelerometer may be present and indicate that the position of the AUV does not change. Other ways to determine that the AUV has reached its target position are possible, e.g., using the INS.

The processor may be programmed to maintain the AUV a predetermined time on the sea bed and record seismic signals and then resurface. Alternatively, the processor may receive an acoustic signal from the vessel that it is time to resurface once this stage is reached. Irrespective of the method of determining when to resurface, the processor instructs the gas valves (all of them) to open so that water is expelled from both chambers 208 and 210. At this time, the valves 224A and 224B may be closed so that no more water enter the chambers and valves 216A and 2168 are open so that the water escape from the chambers. The AUV enters now in the third phase during which the AUV acquires positive buoyancy so that it can resurface. The amount of compressed gas from the gas tank 206 may be in excess of the gas necessary to entirely remove the water from the two chambers. This specific configuration determines a certain quantity of air to be released through the ports 218A and 218B towards the sea bottom. In this way, the body 204 of the AUV may be detached from the mud of the sea bottom. In other words, if the positive buoyancy of the AUV is not enough to make the AUV float towards the water surface, allowing part of the compressed air to exit through the ports 218A and B help to unstuck the AUV from the mud. The piping 220A and 220B may be configured so that the ports 218A and 218B may be located at the opposite ends of the AUV. In one embodiment, the ports 218A and 218B coincide.

Once the AUV has started its journey toward the water surface, the processor may close the air valves until the AUV reaches the water surface or is very close to it. At that instant, the AUV enters the fourth phase, when the buoyancy becomes again neutral. This fourth phase may be achieved by opening water valve 216A and allowing the water to enter the chamber 208. At the same time, the valve 224B may be opened to allow the air inside the escape. In one embodiment, the AUV may skip the third phase and go directly into the fourth phase from the second phase, if so instructed. Alternatively, the AUV may skip the fourth phase. In one embodiment, the processor makes the AUV to enter into the fourth phase as soon as the AUV has left the sea bottom. If the AUV has neutral buoyancy, the navigation system may take over to bring the AUV to the water surface, to a desired rendezvous point.

Once at the water surface or close to it, the AUV waits for the recovery vessel to retrieve it. Alternatively, the AUV may communicate with the recovery vessel and may use its propulsion system to approach the recovery vessel. When on the deck of the recovery vessel, the AUV enters a maintenance phase in which the gas tank 206 is either replaced with a new one or quickly refilled with compressed gas through an air port 232 so that the AUV is ready for a next deployment. For example, the air port 232 may be provided inside the body of the AUV and may be covered by a door 230. Alternatively, the air port 232 may be provided directly on the body of the AUV. The air port is then connected to a source of compressed air, on the vessel, to recharge the gas tank 206.

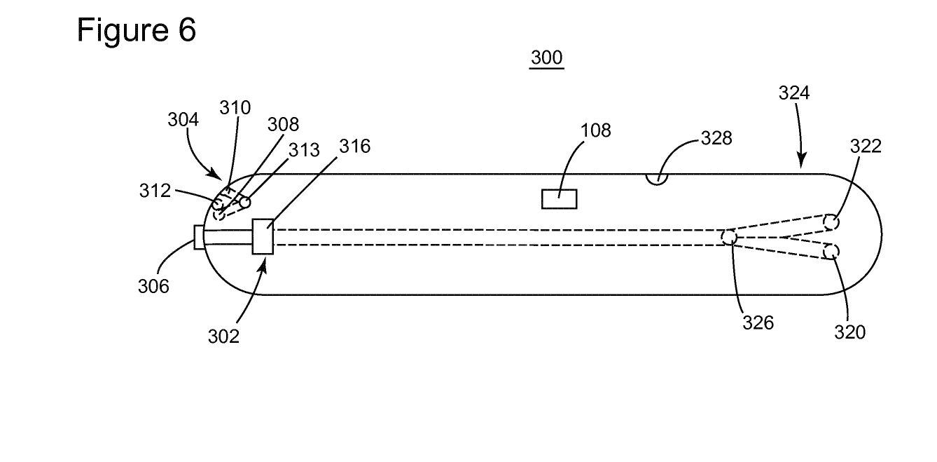

FIG. 6 shows another AUV 300 that can be used for seismic surveys. The AUV 300 has a body 302 in the shape of a submarine. A water intake element 306 may be provided at a nose 304 of the AUV or at another part of the AUV. In addition, one or more guidance nozzles may be provided on the nose 304. FIG. 6 shows three guidance nozzles, one nozzle 310 located on top of the nose 304 and two nozzles 308 and 312 located on the sides of the nose 304. These guidance nozzles may be used to steer the AUV as needed. For example, an impeller or water pump 313 water may be provided inside the AUV for taking in water through the intake element or one of the guidance nozzles and then to expel the water through one or more of the guidance nozzles 308, 310 and 312 for changing the direction of the AUV based on momentum conservation. Another possibility is to have some valves instead of the water pump 313 that allow water entering the water intake element 306 to exit one or more of the guidance nozzles 308, 310 and 312 as desired. Those skilled in the art could imagine other mechanisms for steering the AUV.

In terms of propulsion, the AUV of FIG. 6 may have two propulsion nozzles 320 and 322 at a tail region 324. One or more than two nozzles may also be used. In one embodiment, a water pump 316 may be connected to the propulsion nozzles 320 and 322 for expelling the water through them. A valve 326 may be installed to control how much of the intake water is provided to each of the propulsion nozzles 320 and 322. Thus, it is possible to direct the entire water stream to only one propulsion nozzle. In another embodiment, instead of using the water intake element 306, another water intake element may be used, for example, a water intake element 328 located on the body 302 of the AUV. The pumps and valves are connected to the processor 108 so that control of the AUV can be achieved by the INS. Some or all the elements shown inside the AUV 100 in FIG. 4 may be present inside the AUV 300. In addition, the antenna 128, if present, is provided inside the body 302 of the AUV so that the AUV 300 is flush, i.e., it has no parts that stick out of the body 302.

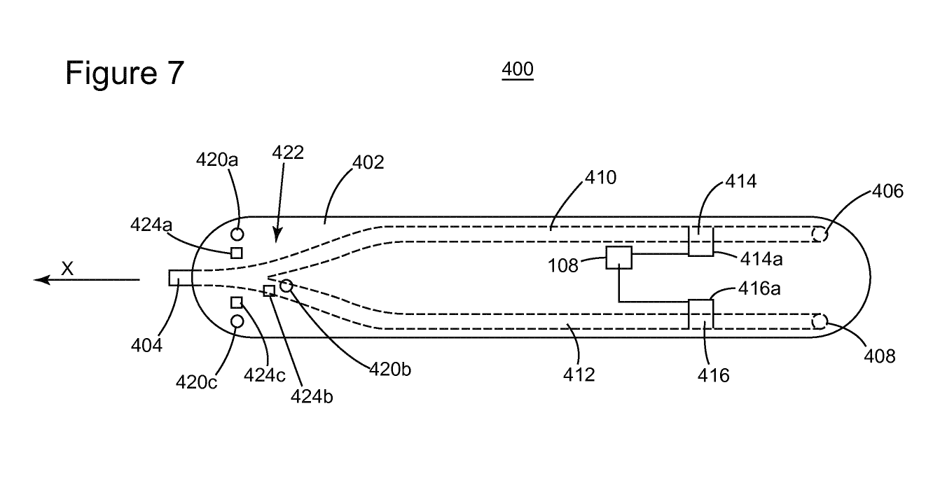

According to another exemplary embodiment illustrated in FIG. 7, an AUV 400 also has a submarine type body with no elements extending out of the body 402. For propulsion, the AUV 400 has a propulsion mechanism that includes an intake water element 404 and two propulsion nozzles 406 and 408. Appropriate piping 410 and 412 connects the intake water element 404 to the propulsion nozzles 406 and 408 through an inside of the AUV. Impellers 414 and 416 may be located in each pipe and connected to corresponding DC motors 414a and 416a, for forcing the water received from the intake water element 404 to exit with a controlled speed or volume at the propulsion nozzles 406 and 408. The two DC motors may be brushless motors and they may be connected to the processor 108 for controlling a speed of the impellers. The impellers may be controlled independently one from the other. Also, the impellers may be controlled to rotate in opposite directions (e.g., impeller 414 clockwise and impeller 416 counterclockwise) for increased stability of the AUV.

If this propelling mechanism is not enough for steering the AUV, guidance nozzles 420a-c may be provided on the bow part 422 of the AUV as shown in FIG. 7. The guidance nozzles 420a-c may be distributed on the sides or corners of a triangle that lays in a plane perpendicular to a longitudinal axis X of the AUV 400. One or three pump jets 424a-c may be also provided inside the body 402 for ejecting water through the guidance nozzles. In this way, a position of the bow of the AUV may be modified/changed while the AUV is moving through the water.

It is noted that all these embodiments may use the multi-phase buoyancy mechanism illustrated in FIG. 5.

With regard to the shape of the AUV, it was noted above that one possible shape is the shape of a submarine. However, this shape may have various cross-sections. For example, a cross-section of the AUV may be circular. In one exemplary embodiment, the cross-section of the AUV is close to a triangle. More specifically, the cross-section may be a triangle having round corners. This shape (triangular-like shape) may be advantageous when deploying or recovering the AUV on the vessel. For example, the launching (and/or recovery) device of the vessel may have a similar triangular shape and also rolling elements that are configured to rotate such that the AUV is lifted from the water into the vessel or lowered from the vessel into the sea. The rolling elements may be located on the launching device so that there is enough contact with the AUV that the AUV does not slip downward when the rolling elements push the AUV upward. Other shapes may be imagined that could be handled by a launching device.

A communication between the AUV and a vessel (deployment, recovery, or shooting vessel) may take place based on various technologies, i.e., acoustic waves, electromagnetic waves, etc. According to an exemplary embodiment, an acoustic underwater positioning and navigation (AUPN) system may be used. The AUPN system may be installed on any one of the participating vessels and may communicate with the acoustic system 130 of the AUV.

The AUPN system may exhibit high accuracy and long range performance in both positioning and telemetry modes. These features are obtained due to the automatic beam forming transducers which focuses the sensitivity towards its targets or transponders. This beam can not only be pointed in any direction below the vessel, but also horizontally and even upwards to the surface as the transducer has the shape of a sphere.

Thus, AUPN is a hydro-acoustic Super Short Base Line—SSBL or USBL, tow tracking system, able to operate in shallow and deepwater areas to proven ranges in excess of 3000 meters. It is a multi-purpose system used for a wide range of applications including towfish and towed platform tracking, high accuracy subsea positioning and telemetry and scientific research.

The AUPN is used to determine the AUV position. In one embodiment, the actual AUV's position is measured with the AUPN and is then provided to the AUV, while moving to its desired position, to correct its INS trajectory.

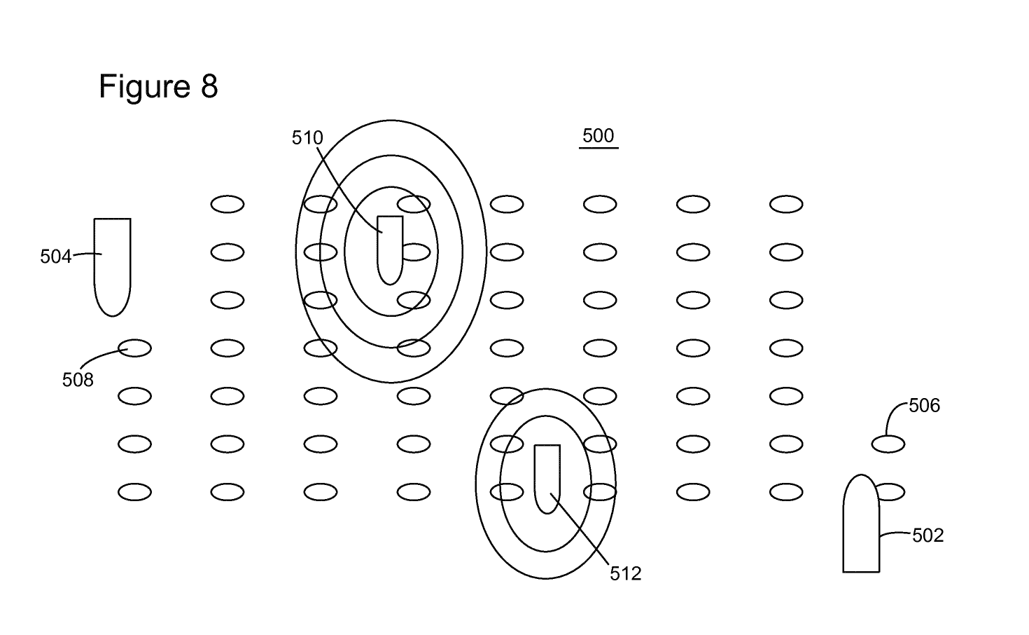

An embodiment for deploying and retrieving AUVs is now discussed with regard to FIG. 8. FIG. 8 shows a seismic system 500 that includes a deployment vessel 502 and a recovery vessel 504. The deployment vessel 502 is tasked to deploy AUVs 506 while the recovery vessel 504 is tasked to recover AUVs 508. The AUV 506 may be any one of those discussed above. In this embodiment, dedicated shooting vessels 510 and 512 follow their own path and generate acoustic waves. In one application, the deployment and recovery vessels do not tow source arrays. Although FIG. 8 shows two shooting vessels, those skilled in the art would appreciate that one or more than two shooting vessels may be used. In another application, the deployment and recovery vessels operate continuously. When the deployment vessel is empty, it switches positions with the recovery vessel. The shooting of the sources may continue while the deployment and recovery vessels switch positions.

The deploying and recovery processes discussed above are just some examples for illustrating the novel concepts of using AUVs for seismic data recording. Those skilled in the art would appreciate that these processes may be changed, adjusted, modified to fit various needs.

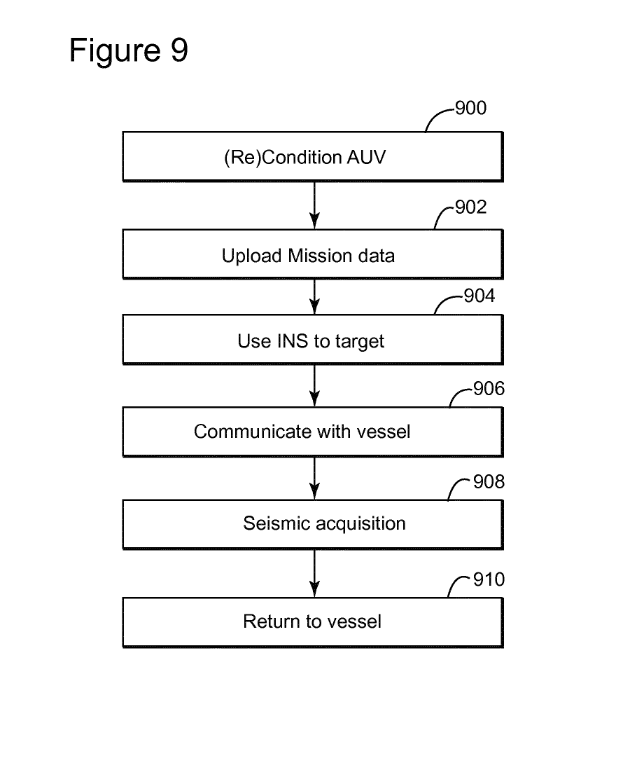

A method for deploying and recovering the AUVs is now discussed with regard to the flowchart presented in FIG. 9. In step 900 the AUV is prepared for launching. This preparation phase, i.e., conditioning the AUV if launched for the first time or reconditioning the AUV if recycled, may include one or more of charging the batteries, replacing or recharging the gas tank, downloading seismic data, checking the system, etc.

In the next step 902, the mission data for that specific AUV is loaded in its processor. This step may take place while the AUV is on the deck of the vessel or the AUV is already loaded in its launching tube or ramp. The mission data may include the present position of the AUV, the final desired position on the bottom of the ocean, and other parameters. After this step, the AUV is launched in step 904 (phase one). The AUV is configured to use, for example, its INS (or acoustic communication or INS combined with acoustic communication) and the uploaded mission data to travel (phase two) to its final destination. In one application, the AUV does not receive any information from the vessel while travelling. However, in another application, the AUV may receive additional information from the vessel, for example, its current position as measured by the AUPN of the vessel. In still another application, beacons may be used to guide the AUV. In still another application, some of the already deployed AUV may function as beacons.

In step 906, after the AUV have settled to the seabed (phase three), the vessel interrogates the AUV about its position. The AUV responds by sending a reference beam and the AUPN of the vessel determines the position of the AUV. The position of the AUV may be determined with an accuracy of, for example, +/−2 m when the AUV is at a depth not larger than 300 m. Alternately, step 906 may be performed between steps 904 and 908, or between steps 908 and 910 or at the beginning of step 910 or both.

After this step, the AUV is ready to record seismic signals in step 908. This process may last as long as necessary. In one application, after the shooting vessel has triggered its source arrays in a predetermined vicinity of the AUV, the AUV is instructed in step 910, for example, using the AUPN of the recovery vessel to wake-up and start resurfacing (phase four). During this step the AUV activates the gas valves, changes its buoyancy from negative to positive, may start its motor if provided with one and moves towards the recovery vessel (the AUV can move in the direction of the recovery catcher, but the relative speed will be high, thus, the AUV may also move in the same direction as the boat, but slower, so that the relative speed is more reasonable, and the AUV can actively position itself to be catched by the catcher when the time is proper). In one application, the recovery vessel is the same with the deployment vessel. The AUV is helped to arrive at the recovery vessel by acoustic signals emitted by the recovery vessel. Once the AUV arrives at the recovery vessel, the AUV engages the recovery unit (e.g., chute) of the recovery vessel and the AUV is handled to arrive on the deck of the vessel for reconditioning as described in step 900. The AUV may also be delivered under the deck of the recovery vessel for the reconditioning (maintenance) phase or in a back deck handling module fixed on the deck. Then, the whole process may be repeated so that the AUVs are constantly reused undersea for the seismic survey.

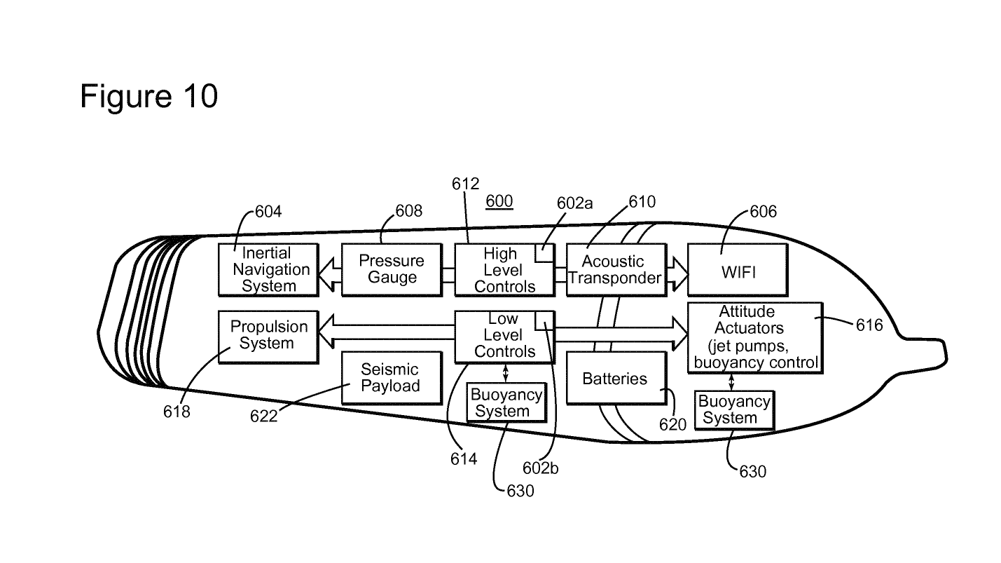

With regard to the internal configuration of the AUV, a possible arrangement is shown in FIG. 10. FIG. 10 shows an AUV 600 having a CPU 602a that is connected to INS 604 (or compass or altitude sensor and acoustic transmitter for receiving acoustic guidance from the mother vessel), wireless interface 606, pressure gauge 608, transponder 610. The CPU 602a may be located in a high level control block 612. The INS is advantageous when the AUV's trajectory has been changed, for example, because an encounter with an unexpected object, e.g., fish, debris, etc., because the INS is capable to take the AUV to the desired final position as it does for currents, wave motion, etc. Also, the precision of the INS may be high. For example, it is expected that for a target having a depth of 300 m, the INS is capable to steer the AUV within +/−5 m of the desired target location. However, the INS may be configured to receive data from the vessel to increase its accuracy. It is noted that the AUV 600 may reach a depth of 300 m for example, using the buoyancy system 630 (similar to the one described in the previous figures). A CPU 602b, in addition to the CPU 602a, is part of a low level control module 614 that is configured to control attitude actuators 616 and the propulsion system 618. One or more batteries 620 may be located in the AUV 600. A seismic payload 622 is located inside the AUV for recording the seismic signals. Those skilled in the art would appreciate that more modules may be added to the AUV. For example, if a sensor is provide outside the body of the AUV, a skirt may be provided around or next to the sensor. A water pump may pump water from the skirt to achieve a suction effect so that a good coupling between the sensor and the seabed is achieved. However, there are embodiments where no coupling with the seabed is desired. For those embodiments, no skirt is used.

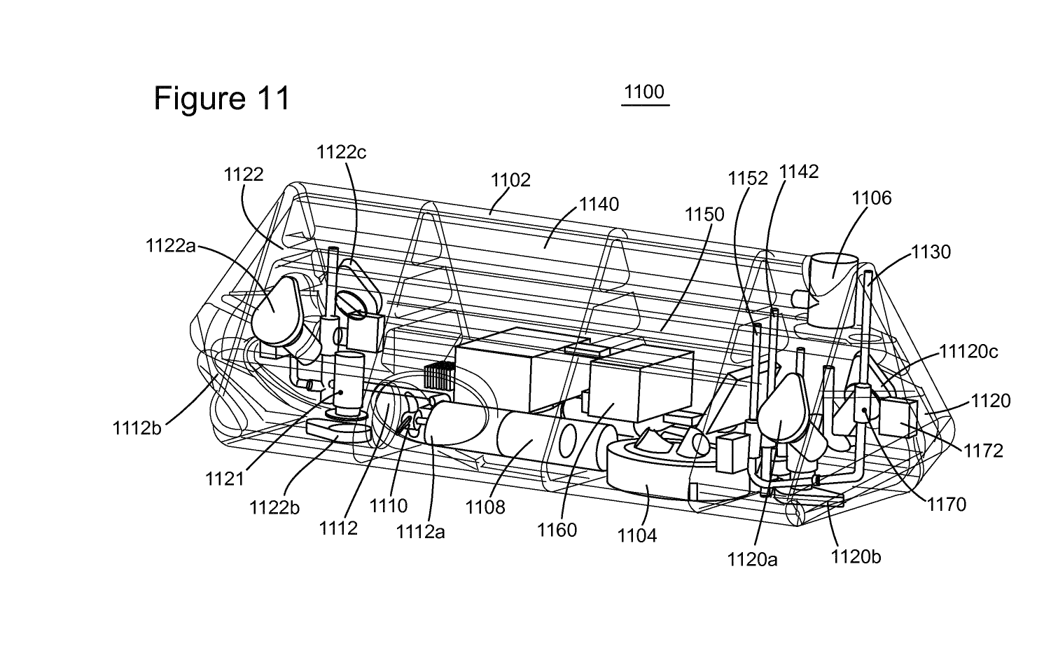

According to an exemplary embodiment, an AUV having two chambers that may be flooded is shown in FIG. 11. The AUV 1100 has a body 1102 with a triangular-like shape. The body may be shaped differently. The body 1102 includes a payload 1104 (e.g., seismic sensors as discussed above) and an acoustic transceiver 1106 that may partially extend outside the body 1102. The acoustic transceiver 1106 is configured to communicate with the vessel and receive acoustic guidance while traveling towards a desired target point. Alternatively, an INS may be used for guidance. Many of the devices discussed in the above embodiments may be present in the body but are neither shown nor discussed with regard to this figure for simplicity.

FIG. 11 also shows a motor 1108 configured to rotate a propeller 1110 for providing thrust to the AUV 1100. One or more motors and corresponding propellers may be used. The propeller 1110 receive water through a channel 1112 formed into the body 1102. The channel 1112 has two openings 1112a (intake water element) and 1112b (propulsion nozzle) that communicate with the ambient water. The two openings may be located on the nose, tail or sides of the body 1102.

Guidance nozzles or turbines may be provided at a nose 1120 and/or at a tail 1122 of the body 1102 for rotation and/or translation control. For simplicity, the guidance nozzles and the turbines are identified by the same reference numbers and are used interchangeable herein although FIG. 11 shows actual turbines. Three guidance nozzles 1120a-c may be located at the nose 1120 and three guidance nozzles 1122a-c may be located at the tail 1122 of the body 1102. The nozzles are connected by piping to corresponding water pumps 1121. If turbines are used instead of nozzles, no piping and no water pumps are necessary. These water pumps may be used to take in water through various vents (not shown) and guide the water thorough one or more of the guidance nozzles at desired speeds. Alternatively, the water pumps may take in the water at one guidance nozzle and expel the water at the other nozzle or nozzles. Thus, according to this exemplary embodiment, the AUV has the capability to adjust the position of its nose with the guidance nozzles (or turbines) 1120a-c and the position of its tail with the guidance nozzles (or turbines) 1122a-c. However, in other embodiments, only the tail nozzles or only the nose nozzles may be implemented.

FIG. 11 also shows chambers 1140 and 1150 that communicate through piping 1142 and 1152 and vents 1130 with the ambient water so that the chambers may be flooded when desired. A control unit 1160 may instruct the water pump to provide water into one or more of the chambers 1140 and 1150 (to partially or fully flood them) so that a buoyancy of the AUV becomes neutral or negative. The same control unit 1160 can instruct the water pump (or use another mechanism) to discharge the water from the one or more chambers so that the buoyancy of the AUV becomes positive. Alternatively, the control unit 1160 instructs one or more actuators 1170 to fluidly connect the vent 1130 to the flooding chamber for making the buoyancy of the AUV negative. For making the buoyancy positive, the control unit 1160 instructs a compressed gas tank 1172 to provide compressed gas (e.g., air, CO₂, etc.) to the flooding chambers to expel the water and then the actuator (e.g., valves) 1170 seals closed the emptied flooding chambers.

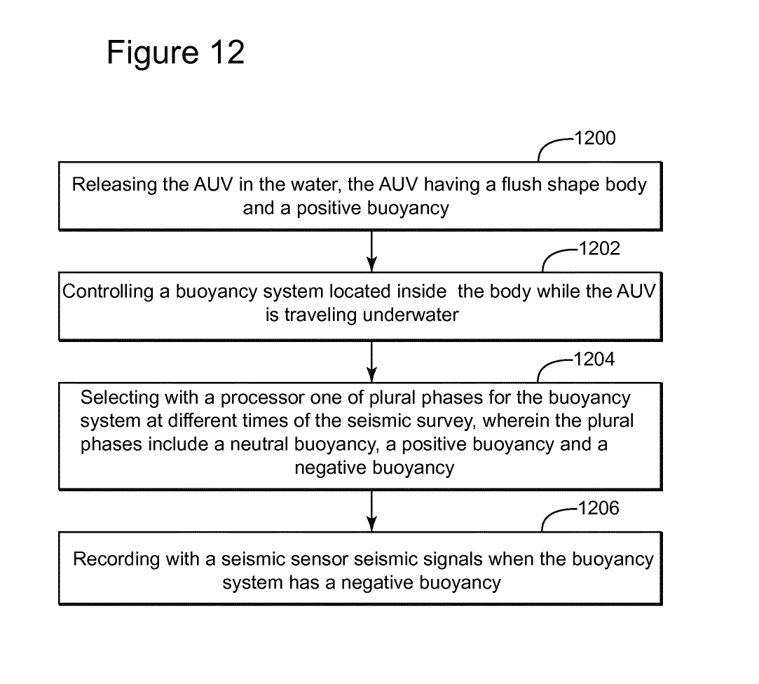

According to an exemplary embodiment illustrated in FIG. 12, there is a method for recording seismic data with a seismic sensor located on an underwater autonomous vehicle. The method includes a step 1200 of releasing the AUV in the water, the AUV having a flush shape body and a positive buoyancy, a step 1202 of controlling a buoyancy system located inside the body while the AUV is traveling underwater, a step 1204 of selecting with a processor one of plural phases for the buoyancy system at different times of the seismic survey, wherein the plural phases include a neutral buoyancy, a positive buoyancy and a negative buoyancy, and a step 1206 of recording with a seismic sensor seismic signals when the buoyancy system has a negative buoyancy.

One or more of the exemplary embodiments discussed above disclose an AUV configured to perform seismic recordings at a target depth. The target depth is achieved by using a multi-phase buoyancy system as described above or its equivalents. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. An autonomous underwater vehicle (AUV) for recording seismic signals during a marine seismic survey, the AUV comprising:
a body having a flush shape;
a buoyancy system located inside the body and configured to control a buoyancy of the AUV while traveling underwater;
a processor connected to the buoyancy system and configured to select one of plural phases for the buoyancy system at different times of the seismic survey, wherein the plural phases include a neutral buoyancy phase, a positive buoyancy phase and a negative buoyancy phase; and
a seismic sensor for recording seismic signals.

2. The AUV of claim 1, wherein the buoyancy system comprises:
a compressed gas tank configured to store compressed gas;
a first chamber fluidly connected to the compressed gas tank; and
a second chamber fluidly connected to the compressed gas tank.

3. The AUV of claim 2, wherein each of the first and second chambers are connected to corresponding ports on the outside of the body to fluidly communicate with an environment of the AUV.

4. The AUV of claim 3, further comprising:
plural gas valves controlled by the processor to release the compressed gas to the first or second chambers;
plural water valves controlled by the processor to flood the first or second chambers; and
plural gas evacuation valves controlled by the processor to allow the gas inside the first and second chambers to escape outside,
wherein the plural gas valves, the plural water valves and the plural gas evacuation valves are controlled to achieve a desired phase of the plural phases.

5. The AUV of claim 4, wherein the processor is configured to open the gas valves and the water valves to remove the water from the first and second chambers.

6. The AUV of claim 4, wherein the compressed gas tank is sized in such a way that compressed gas fills the first and second chambers and also is pumped through corresponding ports outside the body to detach the AUV from the sea bottom.

7. The AUV of claim 2, wherein the neutral buoyancy phase is achieved by flooding with water the first chamber and maintaining a gas inside the second chamber.

8. The AUV of claim 2, wherein the positive buoyancy phase is achieved by maintaining a gas inside the first and second chambers.

9. The AUV of claim 2, wherein the negative buoyancy phase is achieved by flooding with water the first and second chambers.

10. The AUV of claim 1, wherein the buoyancy system is configured to release compressed gas between the AUV and the sea bottom to detach the AUV from the sea bottom.

11. An autonomous underwater vehicle (AUV) for recording seismic signals during a marine seismic survey, the AUV comprising:
a body having a flush shape;
a buoyancy system located inside the body and configured to control a buoyancy of the AUV while underwater;
a processor connected to the buoyancy system and configured to select one of plural phases for the buoyancy system at different times of the seismic survey, wherein the plural phases include a neutral buoyancy, a positive buoyancy and a negative buoyancy;
a propulsion system configured to guide the AUV to a target position on the sea bottom; and
a seismic sensor for recording seismic signals.

12. The AUV of claim 11, wherein the buoyancy system comprises:
a compressed gas tank configured to store compressed gas;
an enclosure fluidly connected to the compressed gas tank.

13. The AUV of claim 12, wherein the enclosure is connected to a port on the outside of the body to fluidly communicate with an environment of the AUV.

14. The AUV of claim 13, further comprising:
plural gas valves controlled by the processor to release the compressed gas to the enclosure;
a water valve controlled by the processor to flood the enclosure; and
a gas evacuation valve controlled by the processor to allow the gas inside the enclosure to escape outside,
wherein the plural gas valves, the water valve and the gas evacuation valve are controlled to achieve a desired phase of the plural phases.

15. The AUV of claim 12, wherein the compressed gas tank is sized in such a way that compressed gas fills the enclosure and also is pumped through the port outside the body to detach the AUV from the sea bottom.

16. The AUV of claim 12, wherein the neutral buoyancy phase is achieved by partially flooding with water the enclosure.

17. The AUV of claim 12, wherein the positive buoyancy phase is achieved by removing water from the enclosure.

18. The AUV of claim 12, wherein the negative buoyancy phase is achieved by flooding with water the enclosure.

19. A method for driving an autonomous underwater vehicle (AUV) for recording seismic signals during a marine seismic survey, the method comprising:
releasing the AUV in the water, the AUV having a flush shape body and a positive buoyancy;
controlling a buoyancy system located inside the body while the AUV is traveling underwater;
selecting with a processor one of plural phases for the buoyancy system at different times of the seismic survey, wherein the plural phases include a neutral buoyancy, a positive buoyancy and a negative buoyancy; and
recording with a seismic sensor seismic signals when the buoyancy system has a negative buoyancy.

20. The method of claim 19, further comprising:
driving the AUV towards a target position on the sea bottom with the buoyancy system having a neutral buoyancy; and
changing the buoyancy of the AUV to become negative after the AUV reaches the sea bottom, or
changing the buoyancy of the AUV to become positive after recording the seismic data.
